(19) United States
(12) Patent Application Publication
(10) Pub. No.: US 2024/0243504 A1
(43) Pub. Date: Jul. 18, 2024

(54) Connector and Connector Assembly

(71) Applicant: Tyco Electronics (Shanghai) Co. Ltd., Shanghai (CN)

(72) Inventors: Jiaoyong (Mac) Liu, Shanghai (CN); Jie (Roger) Luo, Shunde (CN); Hongqiang (Sean) Han, Shanghai (CN)

(73) Assignee: Tyco Electronics (Shanghai) Co. Ltd., Shanghai (CN)

(21) Appl. No.: 18/413,145

(22) Filed: Jan. 16, 2024

(30) Foreign Application Priority Data
Jan. 16, 2023 (CN) 202310075034.6

(51) Int. Cl. H01R 13/24; H01R 13/502

(52) U.S. Cl. CPC H01R 13/24; H01R 13/502

(57) ABSTRACT

A connector includes a housing having a pair of elastic fingers and a pair of terminals at least partially accommodated in the housing. Each of the terminals has a terminal body coupled with the housing and an elastic arm connected to the terminal body. The elastic arms of the terminals face each other and clamp a mating terminal inserted between them. The elastic fingers pass through the terminal bodies of the terminals and press against the elastic arms of the terminals.

### CROSS-REFERENCE TO RELATED APPLICATION

This application claims the benefit of the filing date under 35 U.S.C. § 119(a)-(d) of Chinese patent application Ser. No. 20/231,0075034.6, filed on Jan. 16, 2023.

### FIELD OF THE INVENTION

The present invention relates to a connector and a connector assembly including the connector.

### BACKGROUND

In the prior art, a power supply unit of a data center is electrically connected to metal bars of a cabinet through connectors. The coordination between the mating terminals of the power supply unit and the terminals of the connector may involve non-offset mating or offset mating. In non-offset mating, the mating terminal is inserted into the pair of terminals of the connector in the center, ensuring reliable electrical contact between both terminals of the connector and the mating terminal. However, when offset mating occurs, the terminal at one side of the connector is subjected to a large force, while the terminal at the other side of the connector is subjected to a small force, even without contact. Especially in extreme offset mating, this problem can seriously affect product performance, leading to high and unstable contact impedance of connector products, and reducing the current carrying capacity of connector products during offset mating.

### SUMMARY

A connector includes a housing having a pair of elastic fingers and a pair of terminals at least partially accommodated in the housing. Each of the terminals has a terminal body coupled with the housing and an elastic arm connected to the terminal body. The elastic arms of the terminals face each other and clamp a mating terminal inserted between them. The elastic fingers pass through the terminal bodies of the terminals and press against the elastic arms of the terminals.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of a connector according to an exemplary embodiment of the present invention;

FIG. 3 shows an illustrative perspective view of one terminal of a connector according to an exemplary embodiment of the present invention;

FIG. 4 shows an illustrative perspective view of a connector housing according to an exemplary embodiment of the present invention;

FIG. 5 shows a cross-sectional view of a connector according to an exemplary embodiment of the present invention, wherein the terminals are assembled in the housing;

FIG. 6 shows a cross-sectional view of a connector according to an exemplary embodiment of the present invention, wherein the terminals have not yet been assembled into the housing;

FIG. 7 shows a cross-sectional view of a connector according to an exemplary embodiment of the present invention, showing a symmetrical plane of a pair of terminals; and

FIG. 8 shows a cross-sectional view of a connector according to an exemplary embodiment of the present invention, showing mating terminals inserted between a pair of terminals.

### DETAILED DESCRIPTION OF EMBODIMENTS

Exemplary embodiments of the present disclosure will be described hereinafter in detail with reference to the attached drawings, wherein like reference numerals refer to like elements.

The present disclosure may however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments.

It will be apparent, however, that one or more embodiments may be practiced without these specific details. In other instances, well-known structures and devices are schematically shown in order to simplify the drawing.

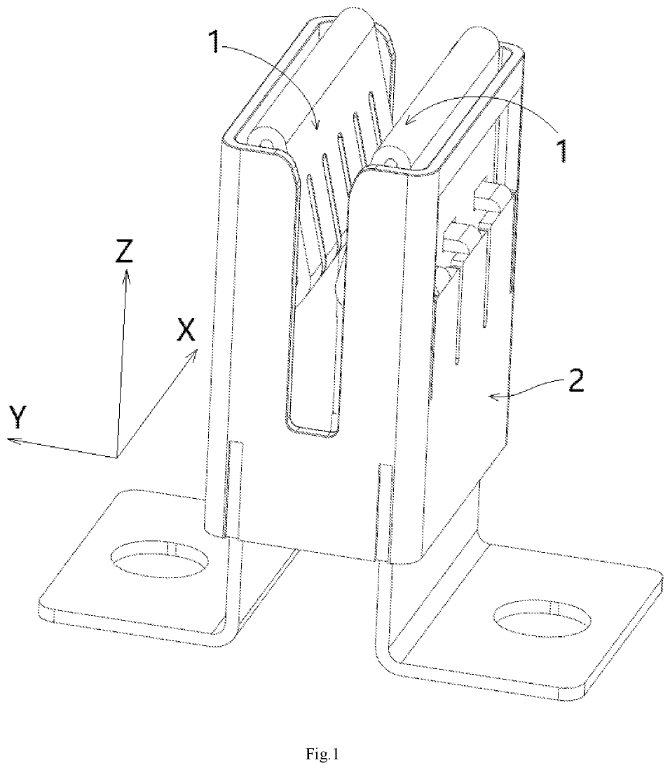

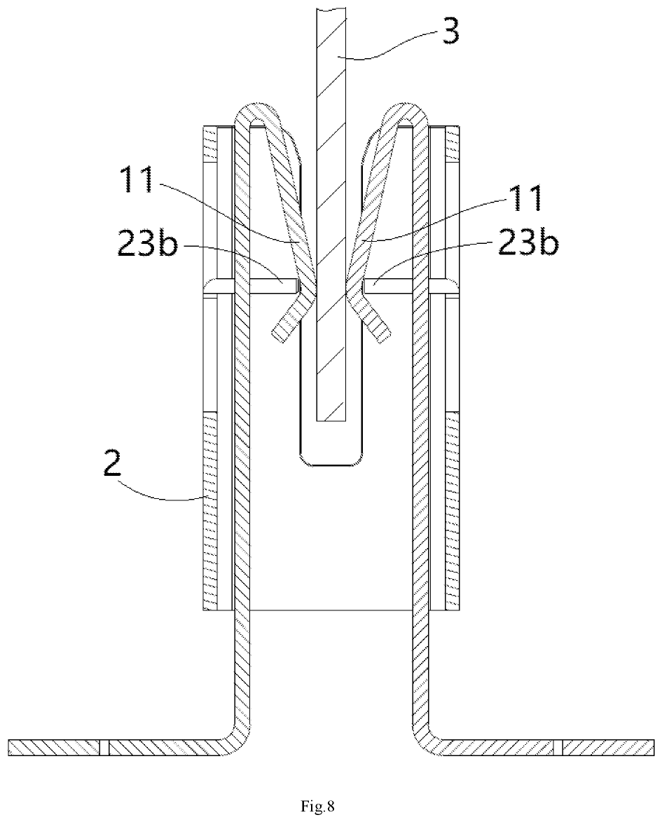

As shown in FIGS. 1 to 4, in an exemplary embodiment of the present invention, a connector is disclosed. The connector includes a pair of terminals 1 and a housing 2. At least a portion of the pair of terminals 1 is accommodated in housing 2 and assembled onto housing 2. FIG. 8 shows a mating terminal 3 inserted between the pair of terminals 1 of the connector.

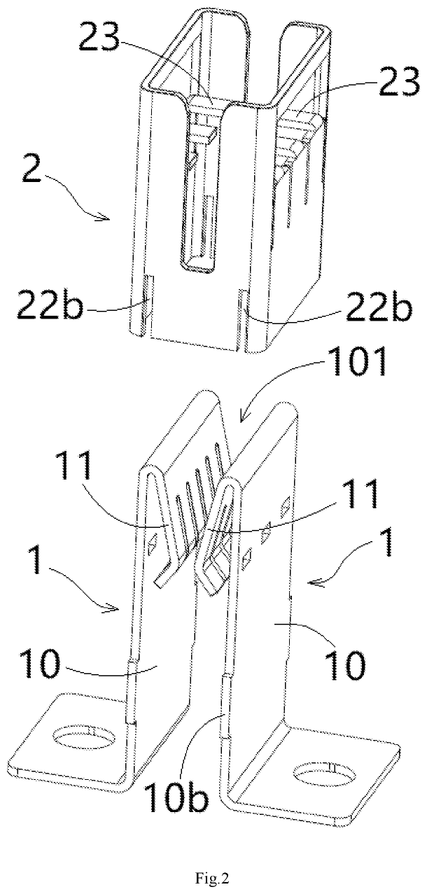

As shown in FIG. 2, each terminal 1 includes a terminal body 10 and an elastic arm 11. The terminal body 10 is fixed to the housing 2, for example, the terminal body 10 can be coupled or joined together with the housing 2. The elastic arm 11 is connected to terminal body 10. As shown in FIG. 8, the elastic arms 11 of the pair of terminals 1 are facing each other, used to clamp the mating terminal 3 inserted between them. In this way, the electrical connection between the mating terminal 3 and the pair of terminals 1 can be achieved.

As shown in FIGS. 2, 4-6 and 8, in the illustrated embodiments, at least one pair of elastic fingers 23 are formed on the housing 2, and each pair of elastic fingers 23 respectively pass through the terminal bodies 10 of the pair of terminals 1, for respectively pressing against the elastic arms 11 of the pair of terminals 1.

As shown in FIG. 8, in the illustrated embodiments, when the mating terminal 3 is inserted between the pair of terminals 1 along a mating plane P, the elastic arms 11 of the pair of terminals 1 undergo elastic deformation under the pushing force of the mating terminal 3, and the elastic deformation of the pair of terminals 1 is basically the same, resulting in a similar contact pressure, thereby ensuring reliable electrical contact between the pair of terminals 1 and the mating terminal 3.

However, when offset mating occurs, that is, when the mating terminal 3 is biased or tilted towards one terminal 1, the elastic deformation of the elastic arm 11 of one terminal 1 is larger, resulting in a larger deformation force, while the elastic deformation of the elastic arm 11 of the other terminal 1 is smaller, resulting in a smaller deformation force. At this time, the contact pressure between one terminal 1 and the mating terminal 3 will be greater than the contact pressure between the other terminal 1 and the mating terminal 3. This would result in unreliable electrical contact between the elastic arm 11 of the other terminal 1 with smaller elastic deformation and the mating terminal 3. However, this problem will not occur in the present invention, as the housing 2 will transfer a part of the elastic deformation force of one terminal 1 to the other through the elastic finger 23, so that the contact pressure between the two terminals 1 and the mating terminal 3 is balanced, thereby ensuring that the elastic arms 11 of the pair of terminals 1 can reliably make electrical contact with the mating terminal 3 and avoiding the problem of unreliable electrical contact between the terminal 1 with small elastic deformation and mating terminal 3.

In the illustrated embodiment, the elastic finger 23 on the housing 2 can not only provide auxiliary contact pressure for the elastic arm 11 of terminal 1, but also balance the offset contact pressure during offset mating. Therefore, the present invention can reduce the contact impedance of terminal offset mating and improve the current carrying capacity of terminal offset mating, so that the pair of terminals 1 can also have stable and reliable electrical contact with the mating terminal 3 during offset mating, greatly improving the electrical connectivity performance of the connector product.

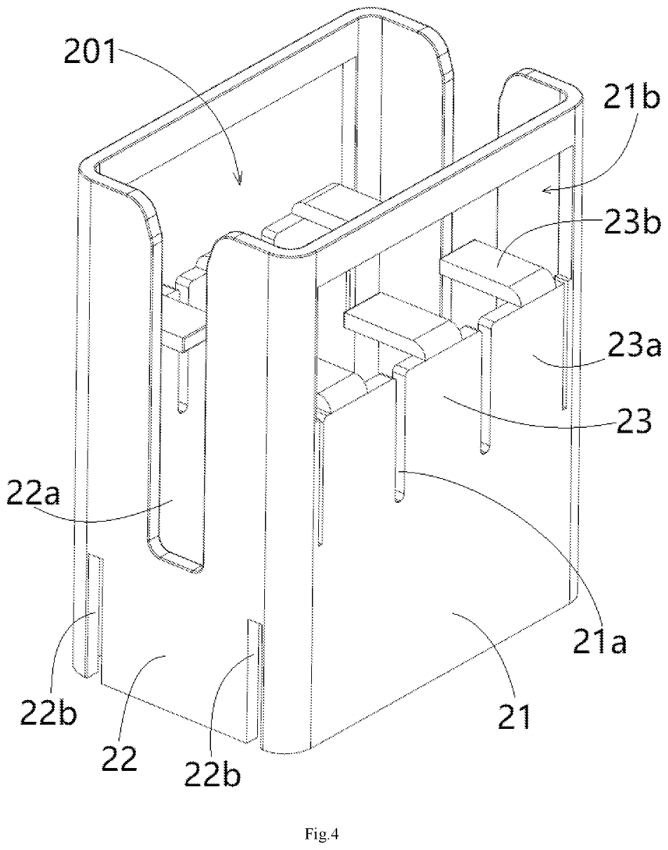

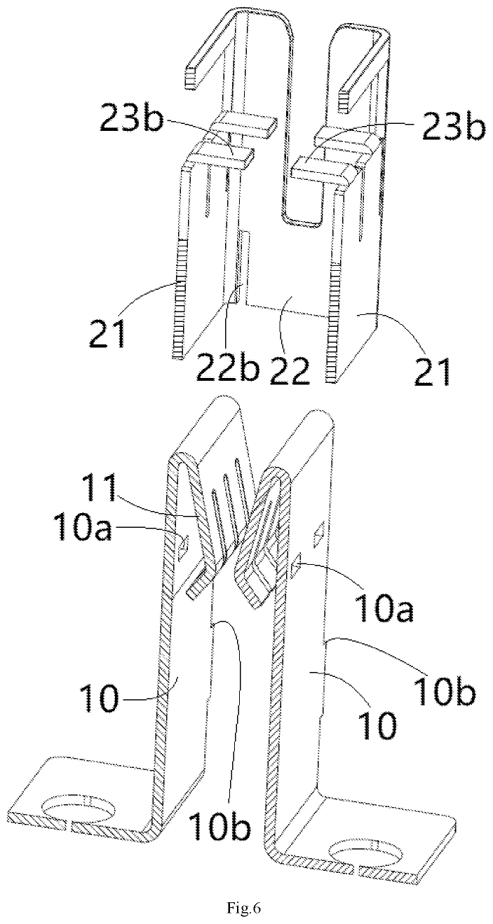

As shown in FIGS. 4 and 6, in the illustrated embodiments, the housing 2 comprises an outer peripheral wall 21 and 22 surrounding an inner cavity 201, and at least a portion of the terminal body 10 and the elastic arms 11 of the pair of terminals 1 are accommodated in the inner cavity 201 of the housing 2. The elastic finger 23 is formed on the outer peripheral wall 21 and 22 of the housing 2 and extends into the inner cavity 201 of the housing 2.

As shown in FIGS. 4 and 6, in the illustrated embodiment, the outer peripheral wall 21 and 22 of the housing 2 includes a pair of first sidewalls 21 and a pair of second sidewalls 22. The pair of first sidewalls 21 are opposite in a first direction Y. The pair of second sidewalls 22 are opposite in a second direction X perpendicular to the first direction Y. The terminal bodies 10 of the pair of terminals 1 are respectively facing the pair of first sidewalls 21, and each pair of elastic fingers 23 are respectively formed on the pair of first sidewalls 21 and respectively pass through the terminal bodies 10 of the pair of terminals 1.

As shown in FIG. 4, in the illustrated embodiment, the elastic finger 23 is L-shaped, and the elastic finger 23 comprises a first finger part 23b and a second finger part 23a. The first finger part 23b extends along the first direction Y. The second finger part 23a extends in the third direction Z perpendicular to the first direction Y and the second direction X. One end of the first finger part 23b is connected to the second finger part 23a, and the other end is used to rest against the elastic arm 11 of the terminal 1.

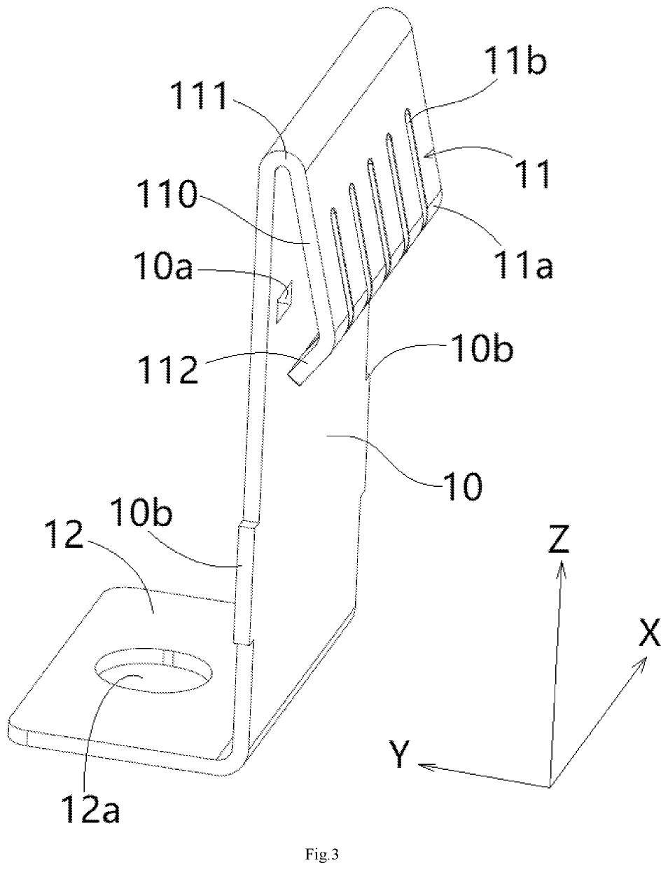

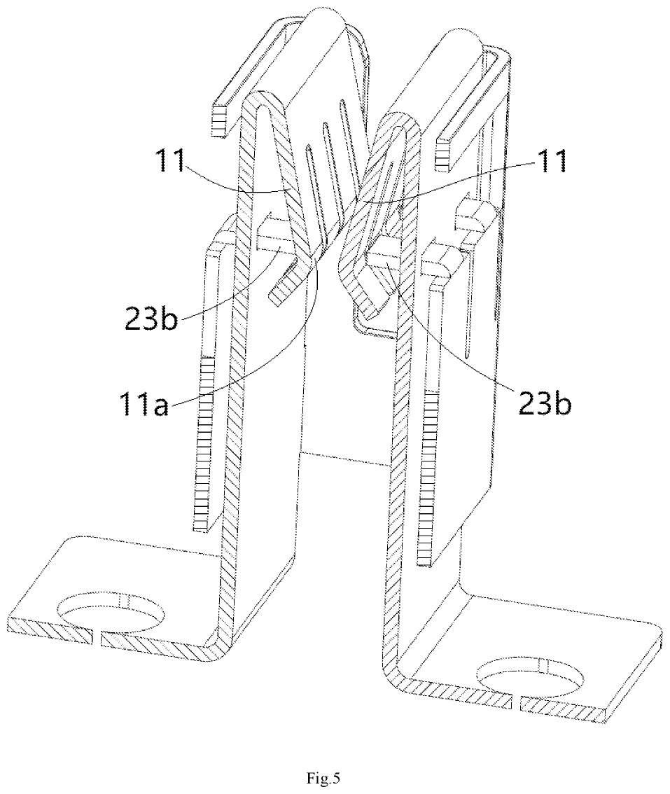

As shown in FIG. 3, in the illustrated embodiments, a through-hole 10a is formed in the terminal body 10 that allows the first finger part 23b to pass through, as shown in FIG. 5, and the first finger part 23b passes through the terminal body 10 through the through-hole 10a. The first finger 23b is matched with the through-hole 10a on the terminal body 10, so that the terminal body 10 cannot be moved in the second direction X and the third direction Z relative to the housing 2. This can limit the position between the pair of terminals 1 and housing 2 in the second direction X and the third direction Z.

As shown in FIG. 4, in the illustrated embodiment, multiple elastic fingers 23 are formed on the first sidewall 21 of the housing 2. Multiple elastic fingers 23 are spaced and arranged in a row in the second direction X. Multiple slits 21a are formed in the first sidewall 21 of the housing 2, which are used to divide the second finger part 23a of multiple elastic fingers 23 on the first sidewall 21. A window 21b connected to multiple slits 21a is formed in the first sidewall 21 of the housing 2, and the first finger part 23b of multiple elastic fingers 23 extends into the inner cavity 201 of the housing 2 through the window 21b.

As shown in FIG. 4, in the illustrated embodiments, slot holes 22b are respectively formed on the pair of second sidewalls 22 of the housing 2, and protrusions 10b are respectively formed on two longitudinal side edges of the terminal body 10, as shown in FIG. 3. The protrusions 10b are respectively engaged in the slot holes 22b of the second sidewall 22.

In the illustrated embodiment, the housing 2 has an upper and lower end opposite to each other in the third direction Z perpendicular to the first direction Y and the second direction X, and the slot hole 22b is located at the lower end of the housing 2 and extends along the third direction Z to the lower end face of the housing 2. In the illustrated embodiment, the protrusion 10b on the terminal body 10 is matched with the slot hole 22b on the housing 2, so that the terminal body 10 cannot be moved in the first direction Y and cannot be moved up in the third direction Z relative to the housing 2. In this way, the position between the pair of terminals 1 and housing 2 in the first direction Y and the third direction Z can be restricted, and the spacing between the two terminal bodies 10 can be ensured to be stable.

As shown in FIG. 4, in the illustrated embodiments, avoidance slots 22a are formed on the pair of second sidewalls 22 of the housing 2, respectively. The avoidance slots 22a extend along the third direction Z to the upper end face of the housing 2. The avoidance slots 22a are used to avoid the two longitudinal side edges of the mating terminal 3, allowing the mating terminal 3 with a width greater than that of the housing 2 to be inserted into the inner cavity 201 of the housing 2.

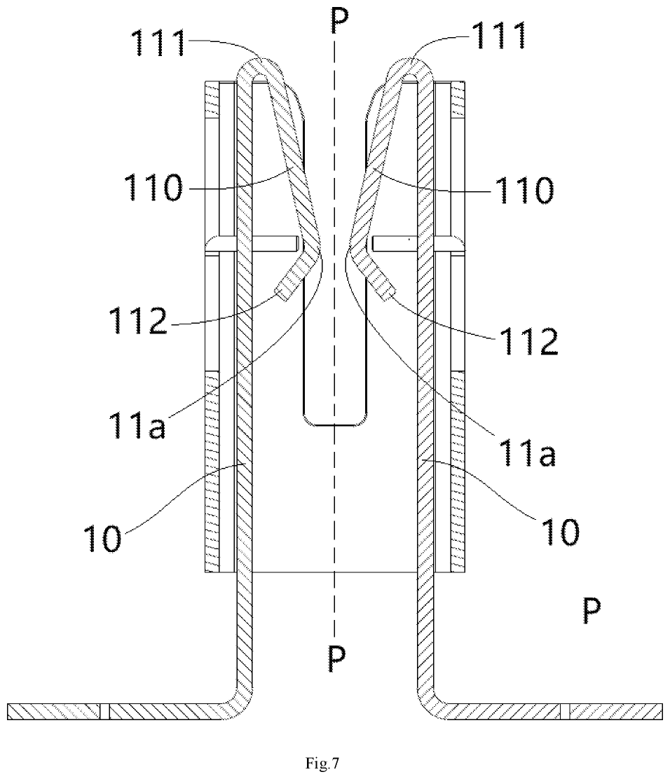

As shown in FIG. 7, in the illustrated embodiment, the elastic arms 11 of the pair of terminals 1 are symmetrically arranged on both sides of a symmetry plane P and extend obliquely relative to the symmetry plane P, so that the elastic arms 11 of the pair of terminals 1 form a V-shape. As shown in FIG. 2, in the illustrated embodiment, a V-shaped slot 101 is defined between the elastic arms 11 of the pair of terminals 1. The V-shaped slot 101 is flared outward to guide the mating terminal 3 to be inserted between the elastic arms 11 of the pair of terminals 1.

As shown in FIG. 3, in the illustrated embodiment, the elastic arm 11 of terminal 1 includes: an arm body 110, an arm root 111, and an arm end 112. The arm body 110 extends obliquely relative to the symmetry plane P. The arm root 111 is bent into an arc and connected between the upper ends of the arm body 110 and the terminal body 10. The arm end 112 is connected to the lower end of the arm body 110 and is bent at a predetermined angle relative to the arm body 110 in a direction away from the symmetry plane P. The arm end 112 has a contact portion 11a connected to the lower end of the arm body 110, which is bent into an arc and has a raised inner surface facing the symmetry plane P. The inner surface of the contact portion 11a is used for electrical contact with the surface of the mating terminal 3.

As shown in FIG. 8, in the illustrated embodiments, when the mating terminal 3 is inserted between the elastic arms 11 of the pair of terminals 1, the elastic fingers 23 on the housing 2 are pressed against the outer side of the contact portion 11a opposite to the symmetrical plane P to provide auxiliary contact pressure to the terminal 1 and balance the offset contact pressure during the offset mating.

In the illustrated embodiment, the first direction Y, the second direction X, and the third direction Z are perpendicular to each other. The symmetry plane P is perpendicular to the first direction Y and parallel to the second direction X and the third direction Z. Multiple separation grooves 11b are formed in the elastic arm 11 of terminal 1, and the multiple separation grooves 11b are spaced and arranged in a row in the second direction X, making the elastic arm 11 comb like. In the shown embodiment, the separation groove 11b extends from the arm body 110 of the elastic arm 11 to the end face of the arm end 112 of the elastic arm 11. In this way, the elasticity of the elastic arm 11 of terminal 1 can be improved.

In the illustrated embodiment, the terminal body 10 of terminal 1 is plate-shaped and parallel to the symmetry plane P, and the first finger part 23b of the elastic finger 23 perpendicularly passes through the through-hole 10a on the terminal body 10 along the first direction Y.

As shown in FIG. 3, in the illustrated embodiment, the terminal 1 further includes a connecting part 12, which is connected to the lower end of terminal body 10 and located at the outside of housing 2. The connecting part 12 is in the shape of a plate, and a connecting hole 12a is formed in the connecting part 12 that allows a connecting piece, such as a screw or bolt, to pass through, so that the connecting part 12 can be electrically connected to a metal bar through the connecting piece.

In the illustrated embodiment, terminal 1 can be an integral metal stamped piece. In this way, manufacturing costs can be reduced. In the illustrated embodiment, the housing 2 can be an integral metal stamped piece or an integral injection molded piece.

In another exemplary embodiment of the present invention, a connector assembly is also disclosed. The connector assembly includes the above connector and a mating terminal 3. The mating terminal 3 is inserted between the elastic arms 11 of the pair of terminals 1 of the connector. The pair of elastic arms 11 of terminal 1 clamp the mating terminal 3 to be electrically connected to the mating terminal 3.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing having a pair of elastic fingers; and
a pair of terminals at least partially accommodated in the housing, each of the terminals has a terminal body coupled with the housing and an elastic arm connected to the terminal body, the elastic arms of the terminals face each other and clamp a mating terminal inserted between them, the elastic fingers pass through the terminal bodies of the terminals and press against the elastic arms of the terminals.

2. The connector according to claim 1, wherein the housing has an outer peripheral wall surrounding an inner cavity, a portion of the terminal bodies and the elastic arms are accommodated in the inner cavity of the housing, the elastic fingers are formed on the outer peripheral wall of the housing and extend into the inner cavity of the housing.

3. The connector according to claim 2, wherein the outer peripheral wall of the housing includes a pair of first sidewalls opposite to each other in a first direction and a pair of second sidewalls opposite to each other in a second direction perpendicular to the first direction, the terminal bodies of the terminals respectively face the pair of first sidewalls, the elastic fingers are respectively formed on the first sidewalls and pass through the terminal bodies.

4. The connector according to claim 3, wherein the elastic fingers are L-shaped and each include a first finger part extending along the first direction and a second finger part extending in a third direction perpendicular to the first direction and the second direction, one end of the first finger part is connected to the second finger part, and another end of the first finger part rests against the elastic arm of one of the terminals.

5. The connector according to claim 4, wherein a through-hole is formed in each of the terminal bodies, the first finger part passes through the terminal body through the through-hole and corresponds with the through-hole so that the terminal body cannot be moved in the second direction and the third direction relative to the housing.

6. The connector according to claim 4, wherein the elastic fingers include a plurality of elastic fingers formed on one of the first sidewalls of the housing, the plurality of elastic fingers on the one of the first sidewalls are spaced from each other in the second direction, a plurality of slits are formed on one of the first sidewalls of the housing and divide the second finger parts of the plurality of elastic fingers on the one of the first sidewalls, a window connected to at least two of the plurality of slits is formed on one of the first sidewalls of the housing, the first finger parts of the elastic fingers on the one of the first sidewalls extend into the inner cavity of the housing through the window.

7. The connector according to claim 3, wherein a slot hole is formed in each of the pair of second sidewalls of the housing, a protrusion is formed on each of a pair of longitudinal side edges of each of the terminal bodies, the protrusions engage in the slot holes in the second sidewalls.

8. The connector according to claim 7, wherein the housing has an upper end and a lower end opposite to the upper end in a third direction perpendicular to the first direction and the second direction, the slot hole is at the lower end of the housing and extends along the third direction to a lower end face of the housing, the protrusion is matched with the slot hole and the terminal bodies cannot be moved in the first direction and cannot be moved upwards along the third direction relative to the housing.

9. The connector according to claim 8, wherein an avoidance groove is formed in each of the pair of second sidewalls of the housing, the avoidance groove extends along the third direction to an upper end face of the housing, the avoidance grooves allow the mating terminal with a width greater than that of the housing to be inserted into the inner cavity of the housing.

10. The connector according to claim 1, wherein the elastic arms of the terminals are symmetrically arranged on both sides of a symmetry plane and extend diagonally relative to the symmetry plane to form a V-shape.

11. The connector according to claim 10, wherein a V-shaped slot is defined between the elastic arms of the terminals, the V-shaped slot is flared outward to guide the mating terminal to be inserted between the elastic arms.

12. The connector according to claim 10, wherein the elastic arm of each of the terminals has an arm body extending obliquely relative to the symmetry plane, an arm root bent into an arc and connected between a pair of upper ends of the arm body and the terminal body, and an arm end connected to a lower end of the arm body and bent at a predetermined angle relative to the arm body in a direction away from the symmetry plane.

13. The connector according to claim 12, wherein the arm end has a contact portion connected to the lower end of the arm body, the contact portion is bent into an arc and has a raised inner surface facing the symmetry plane, the raised inner surface of the contact portion electrically contacts a surface of the mating terminal.

14. The connector according to claim 13, wherein when the mating terminal is inserted between the elastic arms of the pair of terminals, the elastic fingers on the housing are against an outer side of the contact portion opposite to the symmetry plane.

15. The connector according to claim 12, wherein the symmetry plane is perpendicular to the first direction and parallel to the second direction and third direction, the first direction, the second direction, and the third direction are perpendicular to each other, a plurality of separation grooves are formed on the elastic arms of the terminals, and the separation grooves are spaced from each other in the second direction and the elastic arms have a comb like shape.

16. The connector according to claim 15, wherein the separation grooves extend from the arm body of the elastic arm to an end face of the arm end of the elastic arm.

17. The connector according to claim 15, wherein the terminal bodies are plate-shaped and parallel to the symmetry plane, a first finger part of the elastic fingers perpendicularly passes through one of the terminal bodies along the first direction.

18. The connector according to claim 12, wherein the terminals each include a connecting part connected to a lower end of the terminal body and located outside of the housing, a connecting hole is formed in the connecting part that allows a connecting piece to pass through and electrically connect to a metal bar through the connecting piece.

19. The connector according to claim 1, wherein:
the terminal is an integral metal stamped piece, and/or
the housing is an integral metal stamped piece or an integral injection molded piece.

20. A connector assembly, comprising:
a connector including a housing having a pair of elastic fingers and a pair of terminals at least partially accommodated in the housing, each of the terminals has a terminal body coupled with the housing and an elastic arm connected to the terminal body, the elastic arms of the terminals face each other, the elastic fingers pass through the terminal bodies of the terminals and press against the elastic arms of the terminals; and
a mating terminal inserted between the elastic arms of the terminals, the elastic arms clamp the mating terminal and are electrically connected to the mating terminal.
